(19) United States
(12) Patent Application Publication
(10) Pub. No.: US 2020/0269682 A1
(43) Pub. Date: Aug. 27, 2020

(54) VEHICLE FUEL INLET PORT STRUCTURE

(71) Applicant: TOYOTA JIDOSHA KABUSHIKI KAISHA, Toyota-shi (JP)

(72) Inventor: Yoshinori DOMON, Nagoya-shi (JP)

(73) Assignee: TOYOTA JIDOSHA KABUSHIKI KAISHA, Toyota-shi (JP)

(21) Appl. No.: 16/800,499

(22) Filed: Feb. 25, 2020

(30) Foreign Application Priority Data
Feb. 27, 2019 (JP) 2019-034656

(51) Int. Cl. B60K 15/04

(52) U.S. Cl. CPC B60K 15/04; B60K 2015/03315

(57) ABSTRACT

An fuel inlet port structure includes an inlet box having a box shape and having a box opening at its bottom, an inner panel disposed further inward of a vehicle with respect to the inlet box, and an inlet shield inserted through the box opening of the inlet box from outward of the vehicle and disposed between the inlet box and the inner panel. The inlet shield includes a barrel portion having a groove extending circumferentially along part of an entire circumference of an outer surface of the barrel portion at an outer edge.

### CROSS REFERENCE TO RELATED APPLICATION

This application claims priority to Japanese Patent Application No. 2019-034656 filed on Feb. 27, 2019, which is incorporated herein by reference in its entirety including the specification, claims, drawings, and abstract.

### TECHNICAL FIELD

The present disclosure relates to a fuel inlet port structure of a vehicle, and more particularly to a fuel inlet port structure including an inlet shield disposed between an inlet box and an inner panel of a vehicle body.

### BACKGROUND

Fuel inlet port structures for supplying fuel into a vehicle are known (see JP H 06-74452 U, for example).

While referring to FIG. 5, an example related art fuel inlet port structure will be described. FIG. 5 is a cross sectional view illustrating a related art fuel inlet port structure. In FIG. 5, a direction “Out” indicates outward along the width of a vehicle, and a direction “Up” indicates upward along the height of a vehicle, In the following description, the outward direction along the vehicle width will be simply referred to as “outward”, and the inward direction along the vehicle width will be simply referred to as “inward”.

An outer panel 100, and an inner panel 102 disposed further inward with respect to the outer panel 100, together form a body of a vehicle, The outer panel 100 includes an outer panel opening 100a, and the inner panel 102 includes an inner panel opening 102a. An inlet box 104 is a member having a box shape, and includes a box opening 104a at its bottom, The inlet box 104 is inserted into the outer panel opening 100a such that the bottom thereof is oriented inward with respect to the vehicle. A box flange 104b formed on an outer end of the inlet box 104 is engaged with and secured to an outer edge of the outer panel opening 100a. An openable lid 106 is disposed outside the inlet box 104 to cover the inlet box 104.

After the inlet box 104 is inserted into the outer panel opening 100a, an inlet shield 108 is externally fitted in the box opening 104a. The inlet shield 108 prevents entry of liquid such as fuel and water between the outer panel 100 and the inner panel 102, and is formed of a waterproof material, such as a resin. The inlet shield 108 has a barrel shape and includes, on its outer end, a shield flange 108a extending vertically. The inlet shield 108 is externally inserted into the box opening 104a until it abuts against the inner panel 102, and, in this state, the shield flange 108a engages with and is secured to the outer edge of the box opening 104a. The inlet box 104 includes a sealing valve 104c at an edge of the box opening 104a for filling a space between the box opening 104a and the inlet shield 108.

A fuel-receiving member 110 is internally inserted through the inner panel opening 102a and the inlet shield 108. The fuel-receiving member 110 includes an outer leading end that is disposed at a location exposed in the inlet box 104. The fuel-receiving member 110 is a fuel pipe when the fuel is gasoline, for example, and is a receptacle when the fuel is hydrogen.

As described above, the inlet shield is fitted into the box opening of the inlet box. The size (inner diameter) of the box opening therefore needs to match the outer diameter of the barrel portion of the inlet shield.

As the size of the inlet box increases, the size of the lid also increases, which can further increase costs and mass of a vehicle or deteriorate design quality of a vehicle. An increase in the size of the inlet box further raises a need to increase the size of the outer panel opening, lowering the strength of a vehicle. It is therefore desirable that the inlet box should have a smaller size.

An increase in the size of the box opening further causes a need to increase the size of inlet box itself. It is therefore desirable to minimize the size of the box opening in order to avoid an increase in the size of the inlet box.

An embodiment of the disclosure is therefore directed at reducing a size of a box opening of an inlet box in a fuel inlet port structure of a vehicle.

### SUMMARY

A fuel inlet port structure of a vehicle according to the disclosure includes an inlet box having a box opening, an inner panel disposed further inward of the vehicle with respect to the inlet box; and an inlet shield having a barrel portion inserted into the box opening from outward of the vehicle and disposed between the inlet box and the inner panel. The barrel portion includes a groove extending circumferentially along part of an entire circumference of an outer surface of the barrel portion at an outer edge.

It is necessary to make the inner diameter of the box opening of the inlet box match the outer diameter of the barrel portion of the inlet shield, particularly the outer diameter of the outer end of the barrel portion. The above structure including a barrel portion having a groove can reduce the outer diameter of the barrel portion at an outer end, while maintaining the size which allows insertion of a receptacle. Thus, the inner diameter of the opening box of the inlet box can be reduced.

The fuel inlet port structure of a vehicle may further include a receptacle for receiving hydrogen as fuel. The receptacle is inserted through an inner panel opening formed in the inner panel and the inlet shield.

The fuel inlet port structure of a vehicle according to the disclosure has a box opening of an inlet box, having a reduced size,

### BRIEF DESCRIPTION OF DRAWINGS

An embodiment of the present disclosure will be described based on the following figures, wherein:

FIG. 1 is a perspective view of an inlet shield according to the present embodiment;

PIG. 2 is a cross sectional view of the inlet shield observed from direction A-A in

FIG. 3 is a perspective view of the inlet box according to the present embodiment;

FIG. 4 is a cross sectional view of a fuel inlet port structure according to the present embodiment; and

FIG. 5 is a cross sectional view of a fuel inlet port structure of the related art.

### DESCRIPTION OF EMBODIMENTS

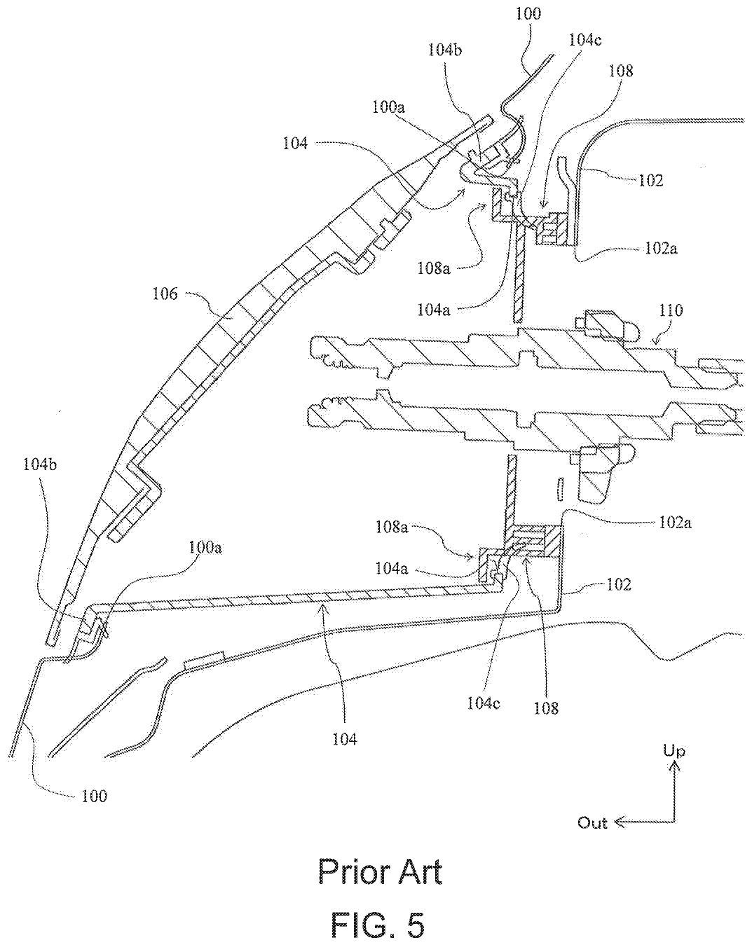

A fuel inlet port structure of a vehicle according to the present embodiment will be described below. The fuel inlet port structure according to the present embodiment differs from the related art fuel inlet port structure illustrated in FIG. 5 in the shape of its inlet shield, and is equivalent to the related art fuel inlet port structure in other portions.

Specifically, the fuel inlet port structure according to the present embodiment includes an inlet box of a box shape having a box opening at its bottom and inserted into an outer panel opening of an outer panel with its bottom directed inward, an inner panel disposed further inward with respect to the outer panel and the inlet box, and an inlet shield externally inserted through the box opening and disposed between the inlet box and the inner panel. The fuel inlet port structure of the present embodiment is an inlet port structure for injecting hydrogen, which is fuel, into a vehicle.

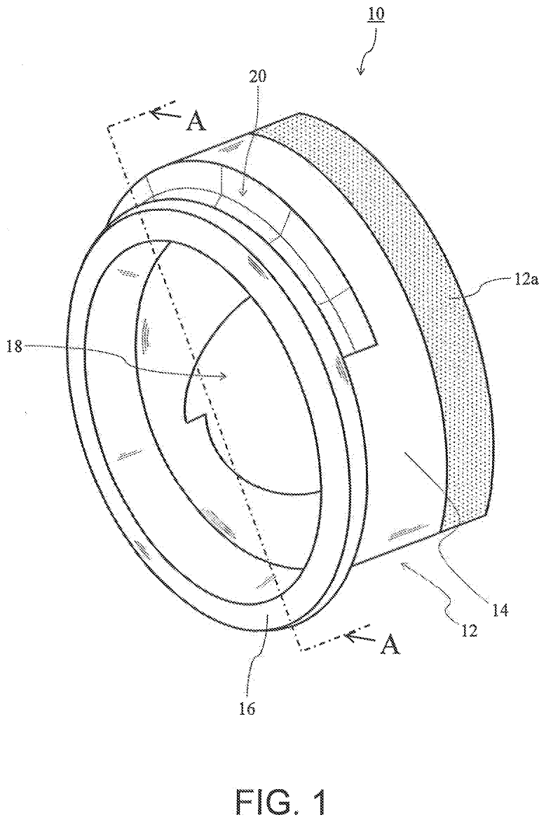

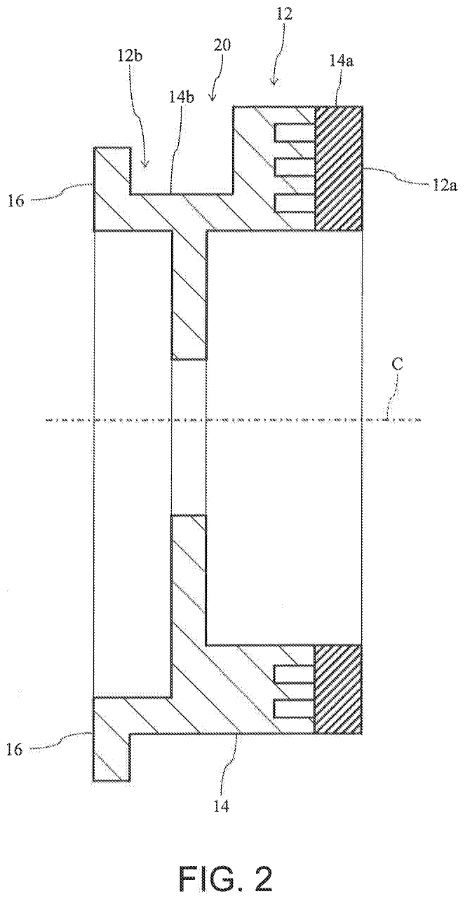

FIG. 1 is a perspective view of an inlet shield 10 according to the present embodiment. The inlet shield 10 includes a barrel portion 12, and a shield flange 16 integrally formed with an end portion of the barrel portion 12 to be eccentric to the barrel portion 12. As will be described below, the barrel portion 12 is externally inserted into a box opening of an inlet box and disposed between the inlet box and an inner panel. The shield flange 16 engages with an outer edge of the box opening.

In the present embodiment, the barrel portion 12 has a substantially cylindrical shape. The barrel portion 12 is formed of a material which does not transmit liquid, such as resin. The barrel portion 12 particularly includes a sealing portion 12a formed of a high-performance sealing member, such as caulking sponge, having a higher liquid sealing property, at an end portion (hatched portion in FIG. 1) opposite the shield flange 16.

The barrel portion 12 has a through hole 18 through which a receptacle serving as a fuel-receiving member for receiving hydrogen, which is fuel, is inserted. To avoid generation of a space between the receptacle and the inlet shield 10, the through hole 18 has a cross sectional shape that conforms to the outer sectional shape of the receptacle.

The barrel portion 12 has an outer surface 14 including a groove 20 extending circumferentially along the barrel portion 12 at an end portion closer to the shield flange 16; that is, at an outward end in the vehicle in its installed state. As illustrated in FIG. 1, the groove 20 is formed only in part of the circumference of the outer surface 14, rather than along the entire circumference.

FIG. 2 is a cross sectional view of the inlet shield 10 observed in direction A-A in FIG. 1. As illustrated in FIG. 2, the groove 20 makes part of the outer surface of barrel portion 12 at the end portion of the barrel portion 12 closer to the shield flange 16; that is, an outer surface 14b at an outer end portion 12b (corresponding to the bottom of the groove 20) located further radially inward toward the center axis C of the barrel portion 12 than is an outer surface 14a of the barrel portion 12 in the sealing portion 12a.

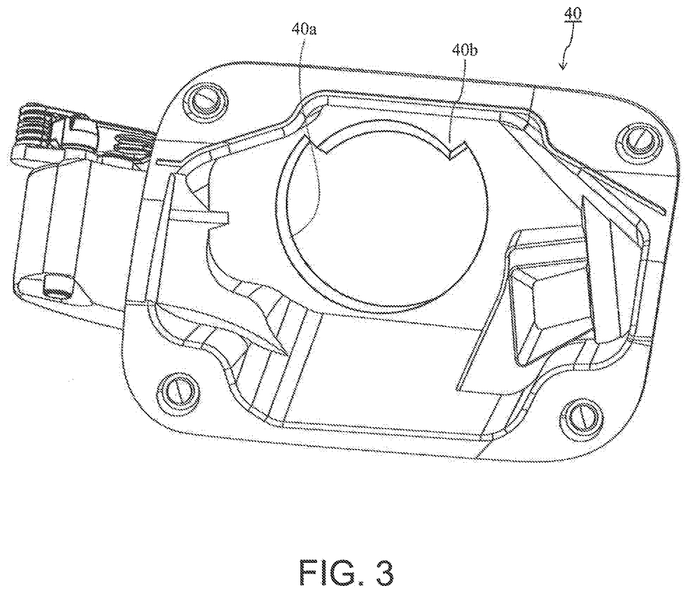

FIG. 3 is a perspective view of an inlet box 40 according to the present embodiment. A box opening 40a partially has a substantially circular shape corresponding to the barrel portion 12 of the present embodiment having a substantially cylindrical shape. However, the box opening 40a includes, in part of the edge portion, a protruding portion 40b protruding inward of the box opening 40a, corresponding to the groove 20 formed partially in the circumferential direction of the barrel portion 12 as described above. This reduces the size of the box opening 40a as compared to a box opening having no protruding portion 40b, by an amount corresponding to the protruding portion 40b. The box opening 40a further includes a sealing valve (not shown in FIG. 3) at its edge portion to till a space between the box opening 40a and the inlet shield 10.

As described above, the size of the box opening 40a may be reduced by forming the groove 20 in the barrel portion 12.

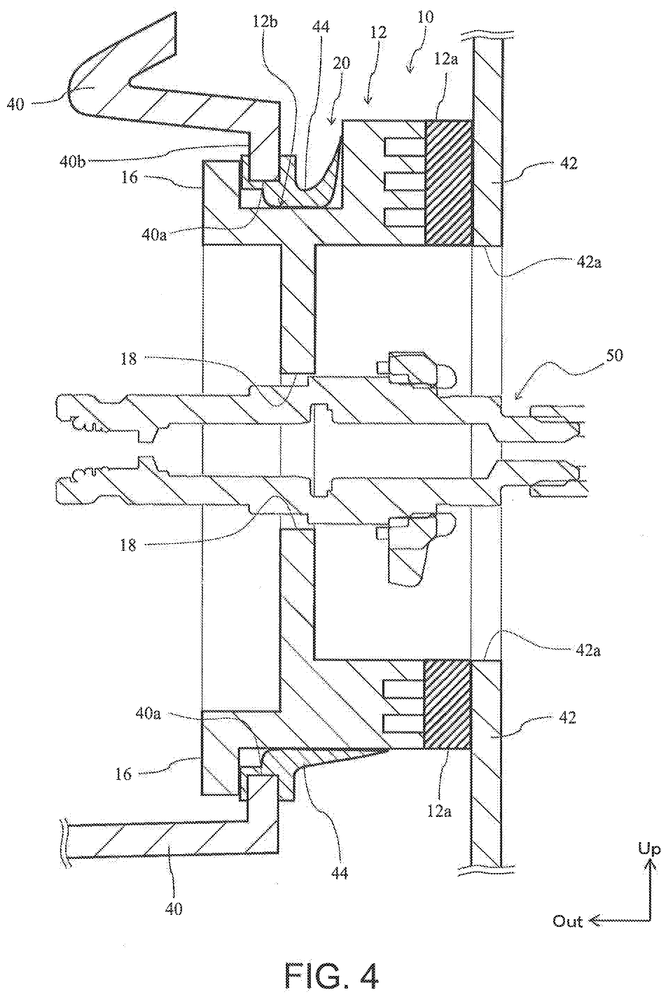

FIG. 4 is a cross sectional view of the fuel inlet port structure according to the present embodiment. The inlet shield 10 is externally inserted through the box opening 40a of the inlet box 40, and, as illustrated in FIG. 4, is pushed until the inward face of the sealing portion 12a comes into contact with the outer face of an inner panel 42. This places the barrel portion 12 between the inlet box 40 and the inner panel 42. A sealing valve 44 is disposed at the edge of the box opening 40a, as described above, and seals a space between the box opening 40a and the inlet shield 10.

The sealing portion 12a and a region of the barrel portion 12 closer to the sealing portion 12a and not including the groove 20 have a substantially cylindrical shape. In contrast, as the box opening 40a includes the protruding portion 40b, as described above, it is not possible to insert the barrel portion 12 into the box opening 40a with the inlet shield 10 in its orientation illustrated in FIG. 4. Therefore, to insert the barrel portion 12 into the box opening 40a, the inlet shield 10 is first tilted such that a region of the inlet shield 10 toward the side where the groove 20 is formed (i.e., the upper region in the example in FIG. 4) is oriented inward to allow the region of the barrel portion 12 including the groove 20 to first pass through the box opening 40a. Then, after, of the region (upper region) of the barrel portion 12 including the groove 20, a region where the sealing portion 12a and the groove 20 are not formed is inserted through the box opening 40a, and the inlet shield 10 is moved toward the groove 20 (toward the upper direction in the example in FIG. 4) to make the protruding portion 40b engage with the groove 20 and simultaneously restore the orientation of the inlet shield 10 as illustrated in FIG. 4. Thereafter, the inlet shield 10 is moved toward the inner panel 42 and pushed until the sealing portion 12a abuts against the outer face of the inner panel 42. In this state, the shield flange 16 engages with the outer edge of the box opening 40a, and thus insertion of the barrel portion 12 into the box opening 40a is completed. In inserting the inlet shield 10 into the box opening 40a, the barrel portion 12 may be inserted into the box opening 40a while somewhat deforming the barrel portion 12 with elasticity.

If the groove 20 is formed along the entire circumference of the outer surface 14 so that the outer edge portion 12b of the barrel portion 12 has a substantially cylindrical shape with its outer diameter smaller than that of the sealing portion 12a and the box opening 40a has a substantially circular shape having an inner diameter corresponding to the outer diameter of the outer edge portion 12b, it is very difficult to insert the barrel portion 12 into the box opening 40a.

As such, the groove 20 formed along part of the entire circumference of the outer surface 14 reduces the size of the box opening 40a and also enables easy insertion of the box opening 40a externally into the barrel portion 12. The groove 20 is formed about a quarter to half of the entire circumference of the outer surface 14, for example.

The fuel inlet port structure according to the present embodiment further includes a receptacle 50 that receives hydrogen as fuel. The receptacle 50 is inserted through the inner panel opening 42a of the inner panel 42 and a through hole 18 of the inlet shield 10 (barrel portion 12), with its outer tip end located within the inlet box 40.

When a hydrogen-injecting gun is attached to the receptacle 50, water adhered to the outer surface of the inlet shield 10 is frozen due to hydrogen, which is fuel, having a low temperature, to make the hydrogen-injecting gun fixed and impossible to remove. According to the present embodiment, the amount of water adhered to the outer surface of the inlet shield 10, which is small, is reduced, so that fixing of the hydrogen injecting gun due to water freezing can be inhibited.

As described above, according to the present embodiment, the groove 20 formed along part of the entire circumference of the barrel portion 12 enables a reduction in the size of the box opening 40a by an amount corresponding to the size of the protruding portion 40b. This further reduces the size of the inlet box 40, thereby preventing an increase in the cost and mass of the vehicle, deterioration of vehicle design quality, or a decrease in the strength of the vehicle,

While an embodiment of the disclosure has been described, the disclosure is not limited to the above embodiment, and various modifications may be made without departing from the gist of the disclosure.

1. A fuel inlet port structure of a vehicle, comprising:
an inlet box having a box opening;
an inner panel disposed further inward of the vehicle with respect to the inlet box; and
an inlet shield having a barrel portion inserted into the box opening from outward of the vehicle and disposed between the inlet box and the inner panel, wherein
the barrel portion includes a groove extending circumferentially along part of an entire circumference of an outer surface of the barrel portion at an outer edge.

2. The fuel inlet port structure of a vehicle according to claim 1, further comprising:
a receptacle for receiving hydrogen as fuel, the receptacle being inserted through an inner panel opening formed in the inner panel and the inlet shield.
